(19) United States
(12) Patent Application Publication
(10) Pub. No.: US 2018/0297501 A1
(43) Pub. Date: Oct. 18, 2018

(54) LOAD BEARING TRAILER

(71) Applicant: Kirk Studer, Spencer, IA (US)

(72) Inventor: Kirk Studer, Spencer, IA (US)

(21) Appl. No.: 15/950,339

(22) Filed: Apr. 11, 2018

Related U.S. Application Data
(60) Provisional application No. 62/486,048, filed on Apr. 17, 2017.

(51) Int. Cl. B60P 1/28; B62D 21/20; B62D 63/08

(52) U.S. Cl. CPC B60P 1/283; B60P 3/00; B62D 63/08; B62D 21/20

(57) ABSTRACT

A trailer for raising and lowering a load including a lifting frame and a base frame configured to secure the load, where a rearward portion of the base frame is rotatably connected at a rear hinge point to the lifting frame. The base frame and the load are raised and lowered based on the tension of a cable attached at one end to the base frame. The tension of the cable is adjusted by a winch attached to the lifting frame. The trailer is configured to allow for an individual operator to raise and lower the load without requiring the assistance of other personnel or facilities.

### FIELD

This disclosure pertains to a device for transporting a load such as a portable housing unit or another large load that is typically transported by trailer or other attached vehicle. More specifically, the disclosure pertains to a device for transporting a load such as a portable housing unit or another large load that is more easily raised or lowered by an individual.

### BACKGROUND

Trailers are commonly used to transport loads including portable housing units, construction dumpsters, materials for construction, and other types of loads, to various locations. Although locations that commonly handle transported loads will include personnel and features such as a loading dock or a ramp that would facilitate the placement and removal of a load on the trailer, such amenities are not available at all locations where such loads are desired. This causes a problem for the individual transporting and unloading the load, particularly if the load is large, unwieldy, heavy, or otherwise not easily handled. Examples of individuals responsible for such loads include individuals who enjoy popular outdoor recreational activities, and construction delivery personnel. When additional personnel and facilities are lacking, the individual must then wait for assistance when unloading or loading the load, or otherwise risk possible injury.

One such popular outdoor recreational activity is ice fishing. Fishing generally includes waiting for extended periods of time while the bait attracts fish. In some climates, participants may benefit from shelter from the elements and may also desire certain amenities such as the ability to recharge their portable electronic devices while waiting for the bait to attract the fish, or the ability to provide a heated enclosure for long periods of cold. Without proper shelter, ice fishing participants could suffer from frostbite and other threats to their health and safety. In addition to providing shelter, fishing houses used for ice fishing typically provide amenities such as sleeping areas, cooking equipment, and electronic devices.

Typically, fishing houses are transported by participants to a desirable location by trailer, and the fishing houses are then deployed onto the frozen surface of a body of water. Such locations are unimproved and lack additional equipment, facilities, and personnel that could assist with the loading and unloading of the fishing house. Some known fishing houses are configured to be deployed when slid off the back of an inclined trailer directly onto the surface. Other known fishing houses include wheels and axles for easy transportation, along with hydraulic or manually operated mechanisms for raising and lowering the structure onto the surface in a manner that allows the bottom of the fishing house to rest on the surface. Although hydraulic and other powered mechanisms may allow for a single operator to easily lower and raise the fish house, typically the manually operated mechanisms require multiple participants or require multiple steps that must be performed in a particular sequence at different ends of the fishing house or fishing house trailer. Further, hydraulic and other powered mechanisms may require an external power source that may be unavailable in some locations.

For example, one known fishing house includes a tilting tongue system that allows for the fishing house to be lowered and raised. First, a tongue-locking pin is removed and a winch is used to raise and lower the front end of the fishing house. The front of the fish house is then lowered to the ground after the removal of the tongue-locking pin. For each of the wheels, a locking pin is removed, and an axle swing arm for the wheels is rotated so that the remainder of the fishing house is lowered to the ground. This can be a multi-step process where the individual partially adjusts one of the wheels, moves to the other wheel and adjusts the other wheel, and then returns to the first wheel and fully adjusts the first wheel. The axles are then removed and the fishing house rests on the desired surface. To raise the fishing house, the process is reversed and can therefore involve a multi-step process of partially raising one of the wheels, fully raising the other wheel, then fully raising the first wheel. A winch is used to raise the front of the fish house. This sequence of steps is time consuming and may be difficult to execute in cold environments.

In another example of a known fishing house, a front winch and two side winches are secured by locking pins and are manually operated to lower and raise the fishing house. First, the individual removes the safety pin from the front winch and operates the winch to lower the front portion of the fishing house. The individual then moves to one of the side winches, removes the locking pin, and operates the side winch to lower the side of the fishing house, and then repeats the process at the other side winch. To raise the fishing house, the individual reverses the process and operates each of the side winches to raise the sides of the fishing house and locks each side winch after completion. The individual then operates the front winch to raise the front portion of the fishing house. Although simpler, this sequence of steps is nevertheless time consuming and may be difficult to execute in cold environments.

There therefore exists a need for a simpler mechanism for raising and lowering a load that has been transported to a particular location. Such loads could include fishing houses, or cargo being transported in an open trailer.

### SUMMARY

Described herein is a trailer for raising and lowering a load, where the trailer includes a winch and a vehicle hitch located at a forward portion of the trailer, a lifting frame where the winch is secured to a forward portion of the lifting frame and at least two wheel hubs at opposite ends of an axle are secured to the lifting frame, a base frame configured to secure the load, a rearward portion of the base frame being rotatably connected at a rear hinge point to the lifting frame, a forward portion of the base frame securing an end of a cable, the cable having a tension adjusted by the winch, and where the base frame and the load are raised and lowered based on the tension of the cable and the rotation of the lifting frame about the axle. The vehicle hitch is rotatably connected at a front hinge point to the base frame at a forward portion of the base frame. The axle is a torsion axle. The forward portion of the lifting frame and the forward portion of the base frame are secured by a locking pin.

### BRIEF DESCRIPTION OF THE DRAWINGS

FIG. 1 depicts an overhead view of an embodiment of the fishing house trailer in the loaded or towing configuration.

FIG. 2 depicts a side view of an embodiment of the fishing house trailer in the loaded or towing configuration.

FIG. 3 depicts a side view of an embodiment of the fishing house trailer in the lowered configuration.

### DETAILED DESCRIPTION

The trailer disclosed here provides a simple mechanism where an individual can operate a single winch to raise and lower a load onto a surface. One example of such a load is a portable housing unit like a fishing house, or cargo such as a construction trailer. Although the disclosure characterizes the subject matter as a fishing house trailer, the same concepts are applicable to other portable housing units and types of loads that integrate the trailer with other components so that a separate trailer is not necessary. The scope of this disclosure therefore includes portable housing unit embodiments or loads where the trailer is incorporated into the portable housing unit or load, even if such an incorporated trailer is not separately described. Moreover, the disclosure is not limited to only a trailer for transporting portable housing units or construction trailer loads, but instead contemplates transportation of other loads where similar issues related to raising and lowering the transported load occur.

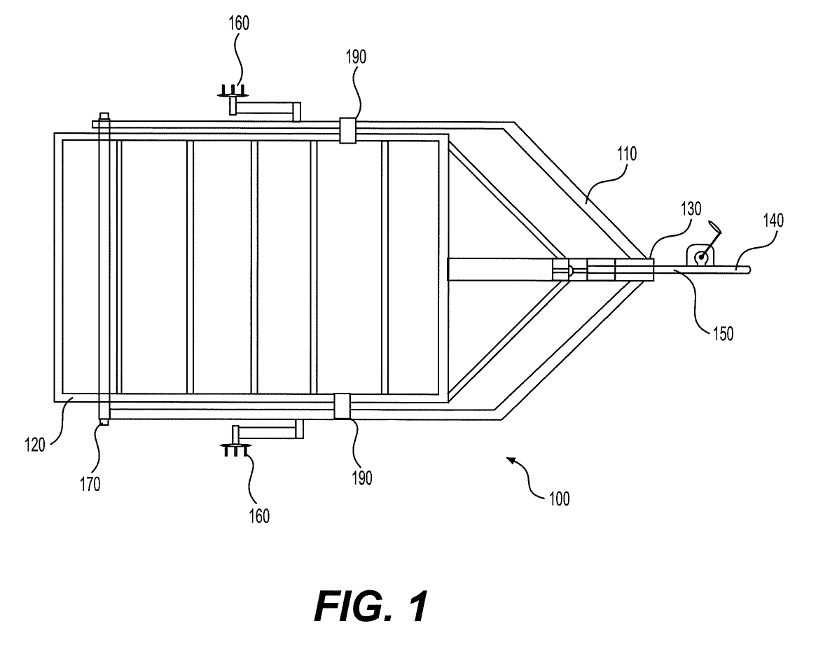

FIG. 1 depicts an embodiment of the trailer 100 from an overhead view. The trailer 100 includes a lifting frame 110 and a base frame 120. The lifting frame 110 is connected to the base frame 120 by a rotatable hinge 170 towards the rear of the trailer 100. Attached to the lifting frame 110 is an axle 162 with two wheels 160, and a winch 130. Operation of the winch 130 raises and lowers the trailer 100 by changing the amount of tension applied to the cable 132 whose free end is secured to the base frame 120. These and other aspects of the trailer disclosed here provide a simpler mechanism for raising and lowering loads such as a portable housing unit.

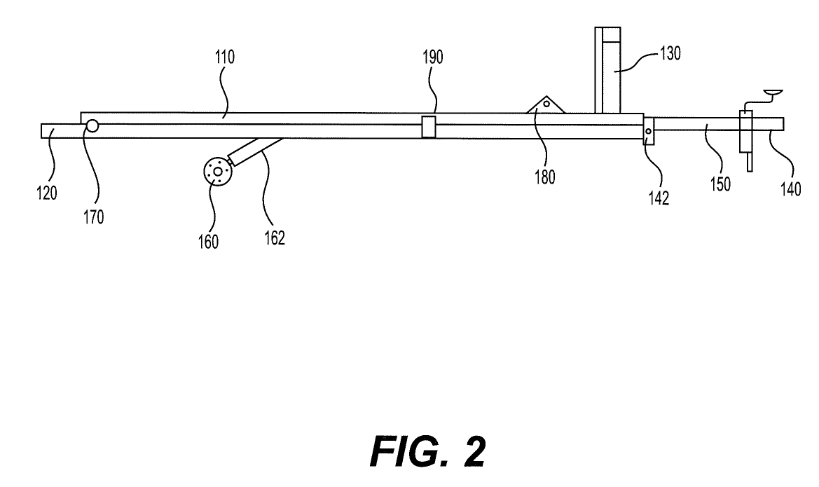

At a forward portion of the trailer 100, a vehicle hitch 140 is provided to allow the trailer 100 to be towed to a desirable location. During deployment of the trailer, the operator may unhitch the vehicle hitch 140 from the towing vehicle. Embodiments of the trailer 100 need not, however, be unhitched to be deployed. Indeed, depending on the embodiment of the trailer 100 and the load being carried, it may be advantageous to remain hitched to the towing vehicle so that additional stability is provided, for example. In some embodiments, a trailer jack may be employed to help support the weight from the trailer 100 and from the load being carried by the trailer 100 during coupling and uncoupling of the trailer 100 from the towing vehicle, for example. The trailer jack may also provide some additional stability while raising and lowering the load and trailer 100. The trailer jack may also be employed for stationary support when the load and trailer 100 have arrived at its destination. The vehicle hitch 140 is connected to the base frame 120 by an extending beam 150 that connects to a hinge point 180 shown in FIG. 2. The hinge point 180 allows for movement of the base frame 120 relative to the vehicle hitch 140. Such movement facilitates the coupling and uncoupling of the trailer 100 from the towing vehicle, and also facilitates the raising and lowering of the load. In the embodiment shown in FIG. 2, the hinge point 180 is tailored to allow for vertical movement of the base frame 120 relative to the vehicle hitch 140.

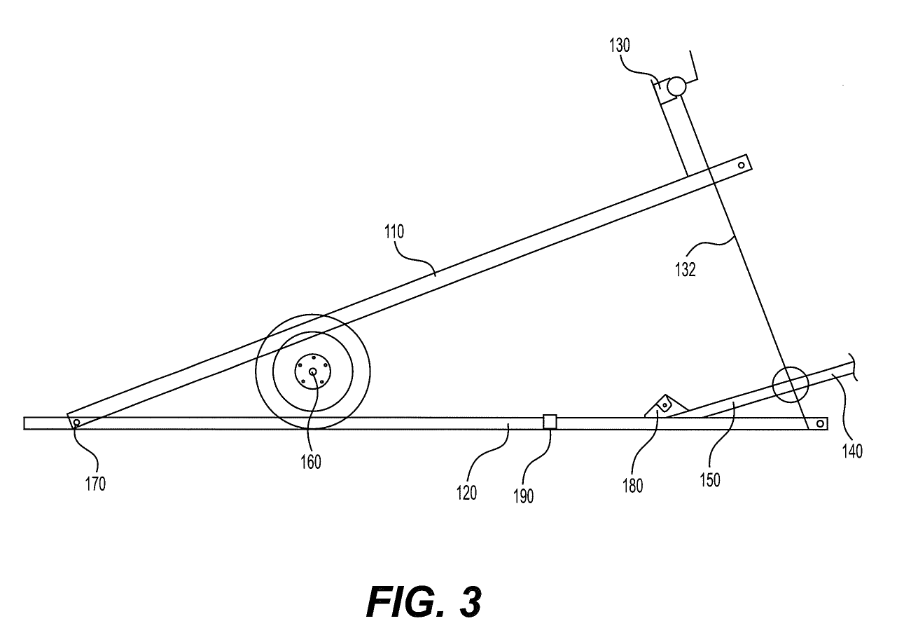

The winch 130 is secured to a portion of the lifting frame 110 that allows the cable 132 wound and unwound by the winch 130 to be secured to the base frame 120. Operation of the winch 130 increases and decreases the amount of tension supplied to the cable 132 and the amount of separation that is allowed between the lifting frame 110 and the base frame 120 to which the end of the cable is secured, as will be discussed below. In the loaded and towing configuration shown in FIGS. 1 and 2, the winch 130 has been operated to tighten the cable 132 so that the lifting frame 110 and the base frame 120 may be secured by a locking pin 142, for example. In the lowered configuration shown in FIG. 3, the winch 130 has been operated to loosen the cable 132 so that the base frame 120 and the load are placed onto a relatively flat surface and so that the lifting frame 110 is raised at an angle. In the embodiment shown in FIG. 1, the winch 130 is a manually operated winch suitable for operation by an individual in a manner that allows for the load to be lowered and raised as desired. In some embodiments, the winch 130 may be powered so as to reduce the burden on the individual. In still further embodiments, the winch 130 may be powered and alternatively manually driven when external power is unavailable.

The lifting frame 110 provides the base to which the winch 130 is attached, provides the base to which the axle 162 is attached with at least two wheels 160, and rotates about the rotatable hinge 170 relative to the base frame 120 depending on the amount of tension in the cable 132. The lifting frame 110 also rotates about the axle 162 during the raising and lowering operation depending on the amount of tension in the cable 132 and depending on the arrangement of the center of mass of the load and trailer 100, as will be discussed below. A forward portion of the lifting frame 110, when lowered and rotated about the axle 162, contacts the extending beam 150 prior to the raising of the base frame 120.

The base frame 120 supports the load to be raised and lowered. In some embodiments, the load is a portable housing unit like a fishing house. In other embodiments, the load is an item for delivery at a particular location such as a construction dumpster. As shown in, for example, FIG. 1, the base frame 120 includes structures that aid in supporting load. FIG. 1 depicts beams extending across the base frame 120 to help support the weight of the load. Other arrangements of supporting structures in the base frame 120 may be utilized to provide a base for the load. In addition to help support the weight of the load, embodiments of the base frame 120 may include other structures may be included with the base frame 120 to help secure the load. For example, at a forward portion of the base frame 120, a lip or a raised set of edges may be formed at the front edge of the base frame 120 so that the load is prevented from shifting forward on the trailer 100 during transport. Similar lips or edges may be formed on the sides of the base frame 120 to prevent the load from shifting laterally on the trailer 100 during transport. In another embodiment, a raised railing may be secured to at least the forward portion of the base frame 120 to further prevent the load from shifting forward on the trailer 100 during transport. Certain embodiments may integrate the base frame 120 with the load, particularly when the load is a portable housing unit. This eliminates the use of a trailer that is separate from the portable housing unit and is suitable for situations where the operator can remain with the load for an extended period of time. In such an embodiment, the base frame 120 will retain aspects of this disclosure that contribute to simplifying the raising and lowering of the fishing house such as the rotatable hinge 170, for example. In these integrated embodiments, the bottom of the portable housing unit may function as a substitute for the base frame 120.

The base frame 120 rotates relative to the lifting frame 110 by way of the rotatable hinge 170. As shown in FIGS. 1-3, the rotatable hinge 170 is placed towards the rear of the trailer 100. In the depicted embodiments, the rotatable hinge 170 is placed closer to the rearmost end of the lifting frame 110 than the rearmost end of the base frame 120. Such an arrangement, along with the placement of the axle 162 to which the two wheels 160 are attached, help facilitate the raising and lowering of the load and trailer. Other arrangements are, however, possible so long as the base frame 120 can continue to rotate relative to the lifting frame 110.

In certain embodiments, the base frame 120 may be configured to include reinforcing components that are particularly suitable for when the trailer is raised and the load is being transported. Typically, the reinforcing component 190 will be secured to the side of the base frame 120 by welding or another technique which permanently joins the reinforcing component 190 to the base frame 120. In at least some embodiments, the base frame 120 and the reinforcing component 190 are integrally formed. In still further embodiments, the base frame 120 and the reinforcing component 190 are removably secured using, for example, a lock and pin. The reinforcing component 190 may be formed in any shape, and of any material, that is appropriate for securing the lifting frame 110 during transport.

FIGS. 1-3 illustrate how a reinforcing component 190 is included on opposite sides of the base frame 120. The specific position and number of reinforcing components 190 may vary depending on the type of loads typically transported. Typically, the reinforcing components 190 are symmetrically distributed around the base frame 120 so that the base frame 120 is evenly secured to the lifting frame 110. In some embodiments, the reinforcing components 190 are unevenly distributed so the base frame is evenly secured to the lifting frame 110. For example, in one embodiment the reinforcing component 190 is a steel U-shaped bracket that is welded to the base frame 120 so that the lifting frame 110 can be placed into the U-shaped bracket when the trailer 100 is moving between locations. In another embodiment, the reinforcing component 190 is a beam secured onto the base frame 120 so that the lifting frame 110 can be placed on the beam when the trailer 100 is moving between locations. In a further embodiment, the reinforcing component 190 may be a bracket that is locked by the operator during transport. Such an embodiment may be particularly desirable over rough terrain, for example.

Each of these reinforcing components 190 help secure the lifting frame 110 to the base frame 120 during transport by supporting the lifting frame 110 and preventing unwanted motion of the lifting frame relative to the base frame 120. The reinforcing component 190 may also help offset some of the load from the base frame 120 during transport. More particularly, some of the load on the base frame 120 is shifted onto the lifting frame 110 so that the load placed onto other components of the trailer 100 including the two wheels 160 and/or the vehicle hitch 140 is reduced, for example. The reinforcing components 190 may be symmetrically or asymmetrically distributed around the base frame 120 to help reduce the load placed on other components of the trailer 100. Such a redistribution of the load from the base frame 120 can, for example, help reduce the load on the axle 162 supporting the two wheels 160, particularly during transport.

The end of the cable 132 discussed above is secured to a portion of the base frame 120 so that changing the tension of the cable 132 by operation of the winch 130 changes the state of the trailer 100 from the loaded and towing configuration shown in FIGS. 1 and 2 to the lowered configuration shown in FIG. 3, for example. The end of the cable 132 may be secured to any structure attached to or integrated with the base frame 120. For example, the end of the cable 132 may be passed through a slot or hole in the base frame 120 and then secured to another portion of the base frame 120 so that changes in the tension of the cable 132 changes the state of the trailer. In other embodiments, a hook, latch, or other component may be secured to the end of the cable 132 and then used to attach the cable 132 to the base frame 120. Other techniques of securing the end of the cable 132 to the base frame are contemplated but not specifically enumerated here. It is, however, preferable that the end of the cable 132 can be resecured by the operator in the event the cable 132 breaks or otherwise requires replacement and/or adjustment.

As shown in the embodiment depicted in FIG. 2, a safety pin 142 may be employed so that the lifting frame 110 and the base frame 120 do not unintentionally separate. The depictions in FIGS. 1 and 2 show the trailer 100 in the loaded or towing configuration where the safety pin 142 is securing the lifting frame 110 and the base frame 120. The depiction in FIG. 3 shows the trailer 100 in the lowered configuration that is achieved when the safety pin 142 is removed and when the winch 130 is operated, as described below. The safety pin 142 may also extend through the extending beam 150 so that this component, in combination with the lifting frame 110 and the base frame 120 are secured. When the safety pin 142 is inserted, the tongue hinge 180 is also secured in position relative to the lifting frame 110, the base frame 120, and the extending beam 150. In some embodiments including the reinforcing components 190, the lifting frame 110 and the base frame 120 are secured in a transportation configuration where the safety pin 142 is inserted. In such embodiments, the reinforcing components 190 are participating in helping to secure the lifting frame 110 to the base frame, and/or are participating in helping offset some of the load of the base frame 120 onto the lifting frame 110.

The base frame 120 extends rearward further than the lifting frame 110 in the embodiments shown in FIGS. 1-3. This, combined with the arrangement of the rotatable hinge 170, the axle 162, the wheels 160, and other features, may provide a balanced center of gravity with respect to the axle 162. More particularly, the center of gravity of the trailer 100 with respect to the axle 162 may be arranged so that the lifting frame 110 and the base frame 120 are not biased towards or apart from each other without additional force. In such an embodiment, the winch 130 may be used to increase the tension on the cable 132 so that the lifting frame and the base frame 120 are brought together, and a safety pin 142 may be inserted to lock the relative positions of the lifting frame 110, the base frame 120, and the extending beam 150. Such an arrangement may, for example, reduce the amount of force that must be provided by the operator to raise and lower the load.

In other embodiments, a slight imbalance in the center of gravity of the trailer 100 with respect to the axle 162 may be desired. Such an imbalance may bias the lowering of the load, particularly when the load is placed on the trailer 100. In such an embodiment, the winch 130 located towards the front portion of the trailer 100 is configured to provide sufficient tension to a cable 132 to ensure the lifting frame 110 does not separate from the vehicle hitch 140 and from the base frame 120. As a result, should such an embodiment include a safety pin 142, the winch 130 must be sufficiently tightened to allow for the insertion of the safety pin 142 to lock the relative positions of the lifting frame 110, the base frame 120, and the extending beam 150.

In still further embodiments, a slight imbalance in the center of gravity of the trailer 100 with respect to the axle 162 biases the raising of the load, particularly when the load is placed on the trailer. In such an embodiment, the lifting frame 110 and the base frame 120 tend to come together, even without additional tension being supplied by the winch 130 and the cable 132. As a result, the winch 130 need not provide tension to cable 132 that ensures the lifting frame does not separate from the vehicle hitch 140 and from the base frame 120. Rather, the imbalance in the center of gravity relative to the axle 162 will bring the lifting frame 110 and base frame 120 towards each other. In such embodiments, a safety pin 142 may be inserted without requiring tightening of the winch 130. In certain embodiments, however, additional tension from the cable 132 may need to be supplied so that the safety pin 142 can be inserted to lock the relative positions of the lifting frame 110, the base frame 120, and the extending beam 150.

The base frame 120 of the trailer 100 may also include additional structures to prevent any unwanted movement of the load during transportation, and during the raising and lowering of the load. For example, portions of the base frame 120 may also include aspects for securing the load including chains, locking pins, bars, or other known securing components including anchor points, anchoring holes, hooks, or other structural features.

As can be appreciated by the depiction in FIG. 3, for example, the amount of cable 132 that is unwound from the winch 130 is related to the angle at which the lifting frame 120 must achieve before the base frame 120 and the load rest on the surface. Other factors such as the placement of the rotatable hinge 170 towards the rear of the trailer, the placement of the axle 162 to which two wheels 160 are attached, and the placement of the winch 130 will also affect the angle at which the lifting frame 120 must achieve before the base frame 120 and the load rest on the surface.

Operation of the trailer 100 will now be discussed. The trailer 100 is towed to an appropriate location for deployment and the operator disengages the vehicle hitch 140 from the towing vehicle. It is, however, not necessary to remove disengage the vehicle hitch 140 from the towing vehicle. The operator then begins the process of lowering the load onto the surface by removing the safety pin 142 that secures the lifting frame 110, the base frame 120, and the extending beam 150. Next, the operator uses the winch 130 to unwind the cable 132. By unwinding the cable 132, the lifting frame 110 initially maintains its position whereas a front portion of the base frame 120 is slowly lowered onto the surface. This movement of the front portion of the base frame 120 relative to the lifting frame 100 is reminiscent of the opening of a clam shell. This rotation of the base frame 120 relative to the lifting frame 110 is possible due to the rotatable hinge 170 that connects the lifting frame 110 and the base frame 120. This rotation of the base frame 120 may also be facilitated by a slight imbalance in the center of gravity, as described above.

After the front portion of the base frame 120 has been lowered onto the surface, the operator continues to operate the winch 130 and unwind the cable 132 so that the front portion of the lifting frame 110 rotates about the axis of the axle 162 and begins to lift upward. Similar to the movement described above, the movement of the front portion of the lifting frame 110 relative to the base frame 120 is reminiscent of the opening of a clam shell. As the front portion of the lifting frame 110 rises, the rear portion of the lifting frame 110 is slowly lowered onto the surface. When the base frame 120 is fully lowered, as depicted in FIG. 3, the lifting frame 110, the rotating hinge 170, and the base frame 120 define an acute angle. As shown in FIG. 3, in this configuration the extending beam 150, the hinge point 180, and the base frame 120 also define an acute angle. Once fully lowered, the operator secures the trailer 100 so that the load and the base frame 120 of the trailer 100 is not unintentionally raised. This may be accomplished by, for example, insertion of a locking pin or other known techniques.

Upon completion of the activity at a given location, the operator unsecures the trailer 100 and uses the winch 130 to wind up the cable 132. The lifting frame 110 is lowered by the additional tension being supplied to the cable 132. The rotation of the lifting frame 110 occurs about the axis of the axle 162. The rotating hinge 170 securing the lifting frame 110 and the base frame 120 also facilitates this lowering of the lifting frame 110. This movement of the front portion of the lifting frame 110 relative to the base frame 120 is similar to the closing of a clam shell. After a portion of the cable 132 has been wound, a front portion of the base frame 120 will begin to rise. The movement of the front portion of the base frame 120 relative to the lifting frame 110 is also similar to the closing of a clam shell. As the operator continues to wind up the cable 132, the lifting frame 110 and the base frame 120 will again come into alignment with each other and with the extending beam so that a safety pin 142 can be inserted to lock the relative positions of the lifting frame 110, the base frame 120, and the extending beam 150.

The placement of the axle 162 about which the lifting frame 110 rotates affects the raising operation and in particular, when the lifting frame 110 stops being lowered and when the base frame 120 starts being raised. In addition, the arrangement of the center of mass of the trailer 100 carrying the load will affect the ease by which the operator raises and lowers the base frame 120.

The embodiments described above include, among other aspects, a cable 132 and a winch 130 that are used to change the state of the trailer 100 from the loaded and towing configuration to the lowered configuration. In other embodiments of the trailer, the cable 132 may be substituted with a chain or other type of linkage whose tension can be used to change the state of the trailer 100. For example, an embodiment of the trailer employing a chain instead, or in addition to, the cable 132, could change the tension so that the state of the trailer is changed from the loaded and towing configuration to the lowered configuration. The usage of such a chain may be particularly useful when larger loads are being transported by the trailer and additional tensioning strength is required to change the state of the trailer. The tension of the chain and/or cable 132 of such an embodiment may be adjusted using a winch 130, or may be adjusted using another type of device that adjusts the tension of the chain and/or cable 132. In still further embodiments, hydraulics may be employed with, or in addition to, the cable 132 so that the ease of use of the trailer is further improved even when the loads being carried by the trailer are substantial. In such an embodiment, a hydraulic linkage may exist between the lifting frame 110 and base frame 120 so that the trailer can transition from the loaded or towing configuration to the lowered configuration based on the amount of extension that is allowed by the hydraulic linkage. In still further embodiments, the rotatable hinge 170 may be driven in a manner where the lifting frame 110 and the base frame 120 of the trailer operate in the above described manner so that a single operator can easily raise and lower the load being transported.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A trailer for raising and lowering a load, the trailer comprising:
a lifting frame and at least two wheel hubs at opposite ends of an axle are secured to the lifting frame;
a base frame configured to secure the load, a rearward portion of the base frame being rotatably connected at a rear hinge point to the lifting frame, a forward portion of the base frame securing an end of a cable, the cable having an adjustable tension; and
wherein the base frame and the load are raised and lowered based on the tension of the cable and the rotation of the lifting frame about the axle.

2. The trailer of claim 1, wherein the vehicle hitch is rotatably connected at a front hinge point to the base frame at a forward portion of the base frame.

3. The trailer of claim 1, wherein the axle is a torsion axle

4. The trailer of claim 1, wherein the forward portion of the lifting frame and the forward portion of the base frame are secured by a locking pin.

5. The trailer of claim 1, wherein when the adjustable tension of the cable is reduced, the base frame and the load are lowered as the lifting frame rotates about the axle.

6. The trailer of claim 1, wherein when the adjustable tension of the cable is increased, the base frame and the load are raised as the lifting frame rotates about the axle.
